(19) United States
(12) Patent Application Publication
(10) Pub. No.: US 2020/0169867 A1
(43) Pub. Date: May 28, 2020

(54) INTERCEPTION METHOD, CORE NETWORK DEVICE AND BASE STATION

(71) Applicant: BAICELLS TECHNOLOGIES CO. LTD., Beijing (CN)

(72) Inventor: Yanguang WU, Beijing (CN)

(21) Appl. No.: 16/082,478

(22) PCT Filed: Mar. 15, 2017
(86) PCT No.: PCT/CN2017/076693

§ 371 Date: Sep. 5, 2018

(30) Foreign Application Priority Data
Mar. 17, 2016 (CN) 201610153053

(51) Int. Cl. H04W 8/08; H04W 80/04; H04W 12/00; H04W 88/16; H04W 84/04; H04L 29/06

(52) U.S. Cl. CPC H04W 8/082; H04W 80/04; H04L 63/306; H04W 88/16; H04W 84/045; H04W 12/007

(57) ABSTRACT

The present disclosure provides an interception method, a core network device and a base station. The method is applied in a Local Break Out (LBO) scenario and includes: obtaining an interception command containing an identifier of a User Equipment (UE) to be intercepted; determining whether the UE to be intercepted is an LBO UE based on the identifier of the UE to be intercepted; transmitting, when the UE to be intercepted is an LBO UE, a first notification message to a base station serving the UE to be intercepted to cause the UE to be intercepted to be reattached; and setting the UE to be intercepted as a non-LBO UE upon receiving an attachment message associated with the UE to be intercepted as transmitted from the base station, to enable a Lawful Interception (LI) device to intercept traffic data for the UE to be intercepted.

The present application claims priority to Chinese Patent Application No. 201610153053.6, titled “INTERCEPTION METHOD, CORE NETWORK DEVICE AND BASE STATION”, filed on Mar. 17, 2016, the contents of which are incorporated herein by reference in its entirety.

### TECHNICAL FIELD

The present disclosure relates to communication technology, and more particularly, to an interception method, a core network device and a base station.

### BACKGROUND

Lawful Interception (LI) is an action allowed by law to intercept communications. It is considered to be a service in a mobile network that is provided for law enforcement and national security departments. When the LI service was initially introduced, it caused great controversy due to issues such as privacy. In many countries, it has undergone acquiescence, constraint, prohibition and then approval. Nowadays, it has been agreed in many countries that such interception should be regulated by legislation, such that the interests of various parties can be balanced while protecting citizens' privacy and preserving national security. In this way, the interception should be supervised under law and should not be abused. Meanwhile, communication departments should provide support for LI.

Conventionally, LI for Serving Gateway (S-GW), Packet Data Network Gateway (PDN-GW) and evolved Packet Data Gateway (ePDG) is provided according to standards defined by the 3^{rd} Generation Partnership Project (3GPP).

With the rapid development of communication technologies, data in mobile networks increases explosively. In order to reduce the load on an evolved Packet Core (EPC) of a mobile network, some local datagrams for low added-value services may be routed directly to a Public Data Network (PDN). This is referred to as Local Break Out (LBO). FIG. 1 is a schematic diagram showing a network deployment structure in an LBO service application scenario.

As shown in FIG. 1, in an LBO scenario, after a User Equipment (UE) has entered a network, its datagrams transmitted from a base station are routed directly to the Internet via a local gateway. That is, the base station serves as the last hop for the UE to route user traffic data locally to the Internet. The LBO has an increasingly wider range of application scenarios in mobile networks.

During implementation of the present disclosure, the inventors have realized at least the following problems in the related art. In a mobile communication network, objects of LI are mainly network element devices in a core network. However, in an LBO scenario, since data is not delivery to S-GW, PDN-GW or ePDG, there is currently no architecture and implementation for LI.

### SUMMARY

The embodiments of the present disclosure provide an interception method, a core network device and a base station, capable of providing LI of user data in an LBO scenario by routing data traffic of a UE to be intercepted back to a core network.

In an aspect, an interception method is provided. The method is applied in a Local Break Out (LBO) scenario and includes: obtaining an interception command containing an identifier of a User Equipment (UE) to be intercepted; determining whether the UE to be intercepted is an LBO UE based on the identifier of the UE to be intercepted; transmitting, when the UE to be intercepted is an LBO UE, a first notification message to a base station serving the UE to be intercepted to cause the UE to be intercepted to be reattached; and setting the UE to be intercepted as a non-LBO UE upon receiving an attachment message associated with the UE to be intercepted as transmitted from the base station, to enable a Lawful Interception (LI) device to intercept traffic data for the UE to be intercepted.

Further, the method can include, subsequent to determining that the UE to be intercepted is an LBO UE based on the identifier of the UE to be intercepted: associating the UE to be intercepted with a mark. The operation of setting the UE to be intercepted as a non-LBO UE upon receiving the attachment message associated with the UE to be intercepted as transmitted from the base station can include: determining whether the attachment message transmitted from the base station is transmitted by the UE to be intercepted based on the mark; and setting the UE to be intercepted as a non-LBO UE when the attachment message transmitted from the base station is transmitted by the UE to be intercepted.

Further, the method can include: transmitting to the base station a second notification message carrying an identifier of the UE to be intercepted that has been set as a non-LBO UE to enable the base station to transmit the traffic data for the UE to be intercepted to a core network based on the second notification message.

Further, the first notification message can further cause the base station to associate the UE to be intercepted with a mark, such that the base station transmits the attachment message after determining that the UE transmitting the attachment message is the UE to be intercepted based on the mark.

Further, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

In another aspect, a core network device is provided. The core network device includes: an obtaining module configured to obtain, in a Local Break Out (LBO) scenario, an interception command containing an identifier of a User Equipment (UE) to be intercepted; a determining module configured to determine whether the UE to be intercepted is an LBO UE based on the identifier of the UE to be intercepted; a transmitting module configured to transmit, when the UE to be intercepted is an LBO UE, a first notification message to a base station serving the UE to be intercepted to cause the UE to be intercepted to be reattached; and a setting module configured to set the UE to be intercepted as a non-LBO UE upon receiving an attachment message associated with the UE to be intercepted as transmitted from the base station, to enable a Lawful Interception (LI) device to intercept traffic data for the UE to be intercepted.

Further, the core network device can include: a marking module configured to associate the UE to be intercepted with a mark, after the determining module has determined that the UE to be intercepted is an LBO UE based on the identifier of the UE to be intercepted. The setting module can be configured to: determine whether the attachment message transmitted from the base station is transmitted by the UE to be intercepted based on the mark; and set the UE to be intercepted as a non-LBO UE when the attachment message transmitted from the base station is transmitted by the UE to be intercepted.

Further, the transmitting module can be further configured to: transmit to the base station a second notification message carrying an identifier of the UE to be intercepted that has been set as a non-LBO UE to enable the base station to transmit the traffic data for the UE to be intercepted to a core network based on the second notification message.

Further, the first notification message can further cause the base station to associate the UE to be intercepted with a mark, such that the base station transmits the attachment message after determining that the UE transmitting the attachment message is the UE to be intercepted based on the mark.

Further, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

In yet another aspect, an interception method is provided. The method is applied in a Local Break Out (LBO) scenario and includes: receiving a first notification message containing an identifier of a User Equipment (UE) to be intercepted as transmitted from a core network; transmitting to the UE to be intercepted a reattachment instruction based on the identifier of the UE to be intercepted; and attaching the UE to be intercepted to the core network upon receiving an attachment message transmitted from the UE to be intercepted, to enable a Lawful Interception (LI) device to intercept traffic data for the UE to be intercepted.

Further, the method can include, subsequent to receiving the first notification message transmitted from the core network: associating the UE to be intercepted with a mark. The operation of attaching the UE to be intercepted to the core network upon receiving the attachment message transmitted from the UE to be intercepted can include: determining whether the attachment message is transmitted by the UE to be intercepted based on the mark; and attaching the UE to be intercepted to the core network when the attachment message is transmitted by the UE to be intercepted.

Further, the method can include: receiving a second notification message indicating that the core network has set the UE to be intercepted as a non-LBO UE; and transmitting the traffic data for the UE to be intercepted to the core network based on the second notification message.

Further, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

In still another aspect, a base station is provided. The base station includes: a receiving module configured to receive, in a Local Break Out (LBO) scenario, a first notification message containing an identifier of a User Equipment (UE) to be intercepted as transmitted from a core network; a transmitting module configured to transmit to the UE to be intercepted a reattachment instruction based on the identifier of the UE to be intercepted; and an attaching module configured to attach the UE to be intercepted to the core network upon receiving an attachment message transmitted from the UE to be intercepted, to enable a Lawful Interception (LI) device to intercept traffic data for the UE to be intercepted.

Further, the base station can include: a marking module configured to associate the UE to be intercepted with a mark, after the first notification message transmitted from the core network has been received. The attaching module can be configured to: determine whether the attachment message is transmitted by the UE to be intercepted based on the mark; and attach the UE to be intercepted to the core network when the attachment message is transmitted by the UE to be intercepted.

Further, the receiving module can be further configured to receive a second notification message indicating that the core network has set the UE to be intercepted as a non-LBO UE, and the transmitting module can be further configured to transmit the traffic data for the UE to be intercepted to the core network based on the second notification message.

Further, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

In an embodiment of the present disclosure, a non-transitory computer readable storage medium is provided. The non-transitory computer readable storage medium stores computer instructions causing a computer to perform any of the above interception methods according to the present disclosure.

In an embodiment of the present disclosure, a computer program product is provided. The computer program product includes a computer program stored on a non-transitory computer readable storage medium. The computer program includes program instructions which, when executed by a computer, cause the computer to perform any of the above interception methods according to the present disclosure.

In an embodiment of the present disclosure, an electronic device is provided. The electronic device includes at least one processor and a memory connected communicatively to the at least one processor. The memory stores instructions executable by the at least one processor for performing any of the above interception methods according to the present disclosure.

With the embodiments of the present disclosure, upon obtaining an interception command containing an identifier of a UE to be intercepted, it is determined whether the UE to be intercepted is an LBO UE based on the identifier of the UE to be intercepted. When the UE to be intercepted is an LBO UE, a first notification message is transmitted to a base station serving the UE to be intercepted to cause the UE to be intercepted to be reattached. Upon receiving an attachment message associated with the UE to be intercepted as transmitted from the base station, the UE to be intercepted is set as a non-LBO UE to enable an LI device to intercept traffic data for the UE to be intercepted. The present disclosure can provide LI of user data in the LBO scenario by routing data traffic of the UE to be intercepted back to a core network.

### BRIEF DESCRIPTION OF DRAWINGS

The figures described herein are provided for further understanding of the present disclosure, and constitute a part of the present disclosure. The illustrative embodiments of the present disclosure and the descriptions thereof are for explaining the present disclosure, rather than unduly limiting the present disclosure. In the figures:

FIG. 1 is a schematic diagram showing a network deployment structure in an LBO service application scenario;

FIG. 2 is a first flowchart illustrating an interception method according to an embodiment of the present disclosure;

FIG. 3 is a second flowchart illustrating an interception method according to an embodiment of the present disclosure;

FIG. 4 is a schematic diagram showing a structure of a core network device according to an embodiment of the present disclosure;

FIG. 5 is a schematic diagram showing a structure of a base station according to an embodiment of the present disclosure; and

FIG. 6 is a schematic diagram showing a hardware structure of an electronic device that performs the interception method according to an embodiment.

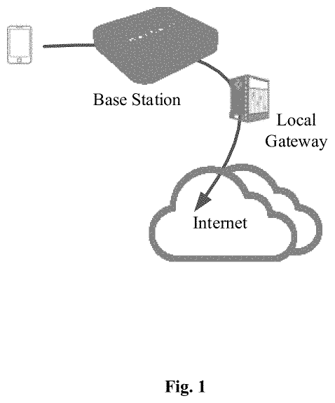

### DESCRIPTION OF EMBODIMENTS

The technical solutions according to the embodiments of the present disclosure will be described clearly and completely in the following with reference to the figures in the embodiments of the present disclosure, such that the objects, solutions and advantages of the embodiments of the present disclosure will become more apparent. The described embodiments are only some, rather than all, embodiments of the present disclosure. All other embodiments obtained by those of ordinary skill in the art based on the embodiments of the present disclosure without any inventive efforts are to be encompassed by the scope of the present disclosure.

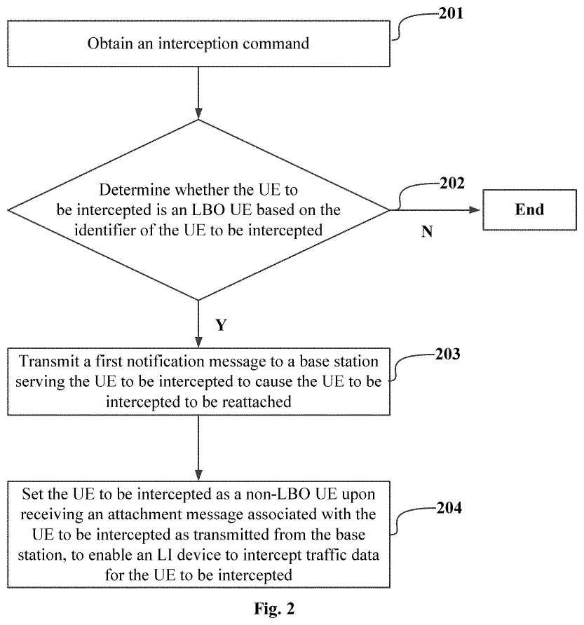

In order to solve the problem in the related art that LI cannot be provided in an LBO scenario, an interception method is provided according to the present disclosure. In particular, as shown in FIG. 2, the method is applied in an LBO scenario and includes the following steps.

At step 201, an interception command is obtained.

The interception command contains an identifier of a UE to be intercepted.

In particular, the interception command can be obtained by a network element in a core network, e.g., a Mobile Management Entity (MME) in the core network, which can be the MME managing the UE to be intercepted. Of course, it can be any other network element as desired. After an LI device obtains the identifier of the UE to be intercepted, it transmits the identifier to a Home Subscriber Server (HSS) in the core network. The HSS finds an MME to which the UE to be intercepted belongs based on the identifier and returns the found result to the LI device. Then, the LI device transmits the interception command to the MME to which the UE to be intercepted belongs. An object of the present disclosure is to allow the MME to which the UE to be intercepted belongs to obtain the interception command. Accordingly, any method capable of allowing the MME to which the UE to be intercepted belongs to obtain the interception command is to be encompassed by the scope of the present disclosure.

The identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

In particular, each UE in a communication network has a unique identifier by which different UEs are distinguishable and can be found uniquely.

At step 202, it is determined whether the UE to be intercepted is an LBO UE based on the identifier of the UE to be intercepted. If so, the method proceeds with the step 203; otherwise it ends.

In particular, the MME is a key control node of the 3GPP Long Term Evolution (LTE) access network and is responsible for locating and paging (including relaying) processes for UEs in an idle mode. It is involved in a bearer activation/deactivation process. When a UE is initialized and connected, an SGW is selected for it. A UE is authenticated by interaction with the HSS and a temporary identifier is assigned to the UE. Meanwhile, the MME has a function of intercepting and sensing traffic data of UEs within the scope allowed by law.

Here, the LBO UE refers to a UE whose traffic is transmitted from a base station and routed directly to the Internet via a local gateway, without passing through the core network.

In a feasible solution, the method can include, subsequent to determining that the UE to be intercepted is an LBO UE based on the identifier of the UE to be intercepted: associating the UE to be intercepted with a mark.

In particular, in order to ensure that, when the UE to be intercepted is reattached, the MME can correctly determine the attached UE to be a UE to be intercepted and stop LBO process for the UE to be intercepted after it has been reattached, the UE to be intercepted needs to be marked. In particular, the identifier of the UE to be intercepted as stored in the MME can be marked. The marking can be performed in various ways, which are all to be encompassed by the scope of the present disclosure as long as the mark can enable the MME to correctly determine the attached UE to be a UE to be intercepted.

At step 203, a first notification message is transmitted to a base station serving the UE to be intercepted to cause the UE to be intercepted to be reattached.

In a feasible solution, the first notification message further causes the base station to associate the UE to be intercepted with a mark, such that the base station transmits the attachment message after determining that the UE transmitting the attachment message is the UE to be intercepted based on the mark.

In particular, after the MME has determined that the UE to be intercepted is an LBO UE, in order to intercept the UE to be intercepted, it needs to be reattached, such that its traffic will not be subjected to LBO, but instead pass through the core network. In this way, the core network can intercept the traffic of the UE to be intercepted. In order to allow the UE to be intercepted to be reattached, a first notification message needs to be transmitted to a base station serving the UE to be intercepted to cause the UE to be intercepted to be reattached, and then the base station can transmit a reattachment command to the UE to be intercepted. Meanwhile, as the first notification message is to cause the UE to be intercepted to be reattached, in order to ensure that the base station can identify the UE to be intercepted when it is reattached, the base station can also mark the UE to be intercepted. The marking may or may not be performed in the same way the MME marks the UE to be intercepted. All marking schemes are to be encompassed by the scope of the present disclosure as long as it allows identifying the reattached UE to be a UE to be intercepted.

At step 204, upon receiving an attachment message associated with the UE to be intercepted as transmitted from the base station, the UE to be intercepted is set as a non-LBO UE, to enable an LI device to intercept traffic data for the UE to be intercepted.

In a feasible solution, the operation of setting the UE to be intercepted as a non-LBO UE upon receiving the attachment message associated with the UE to be intercepted as transmitted from the base station can include: determining whether the attachment message transmitted from the base station is transmitted by the UE to be intercepted based on the mark; and setting the UE to be intercepted as a non-LBO UE when the attachment message transmitted from the base station is transmitted by the UE to be intercepted.

In particular, upon receiving a command requiring it to be reattached, the UE to be intercepted is reattached. The UE to be intercepted transmits a reattached message to the base station, such that the base station can transmit the attached message to the core network. In turn, the core network can reconfigure a data process for the UE to be intercepted. Upon receiving the attachment message, the base station determines whether the UE transmitting the attachment message is a UE to be intercepted or not based on the mark. If so, no LBO process is applied to the attachment message; otherwise an original process is applied for the UE. When it is determined that the UE transmitting the attachment message is a UE to be intercepted, the attachment message is transmitted to the core network. Upon receiving the attachment message, the core network also needs to determine whether the UE transmitting the attachment message is a UE to be intercepted or not based on the mark. If so, the UE to be intercepted is set as a non-LBO UE, such that data for the UE to be intercepted will not be subjected to LBO and can be obtained by the core network. Otherwise, an original process is applied for the UE.

In a feasible solution, the method can include, subsequent to setting the UE to be intercepted as a non-LBO UE: transmitting to the base station a second notification message carrying an identifier of the UE to be intercepted that has been set as a non-LBO UE to enable the base station to transmit the traffic data for the UE to be intercepted to the core network based on the second notification message.

In particular, in order to ensure that the base station can also operate according to the setting of the UE to be intercepted by the core network, the core network needs to transmit a second notification message carrying an identifier of the UE to be intercepted that has been set as a non-LBO UE to the base station. In response to the second notification message, the base station also sets the UE to be intercepted as a non-LBO UE. Upon receiving data traffic transmitted from the UE to be intercepted, the base station transmits the data traffic to the core network such that the core network can intercept the data traffic of the UE to be intercepted. The second notification message is transmitted to the base station before completion of the reattachment of the UE.

As the data traffic of the UE to be intercepted passes through the core network in this case, any existing LI scheme can be applied and details thereof will be omitted here.

Moreover, when the intercepted UE is not to be intercepted any more, the core network transmits to the base station a message causing the intercepted UE to be reattached. When the intercepted UE is attached, it is set as an LBO UE again.

With the present disclosure, upon obtaining an interception command containing an identifier of a UE to be intercepted, it is determined whether the UE to be intercepted is an LBO UE based on the identifier of the UE to be intercepted. When the UE to be intercepted is an LBO UE, a first notification message is transmitted to a base station serving the UE to be intercepted to cause the UE to be intercepted to be reattached. Upon receiving an attachment message associated with the UE to be intercepted as transmitted from the base station, the UE to be intercepted is set as a non-LBO UE to enable an LI device to intercept traffic data for the UE to be intercepted. The present disclosure can provide LI of user data in the LBO scenario by routing data traffic of the UE to be intercepted back to a core network, without modifications to the existing communication structure.

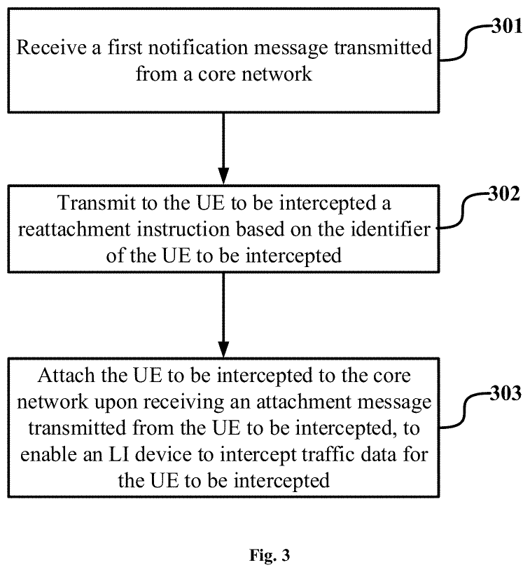

Further, an interception method is provided according to the present disclosure. In particular, as shown in FIG. 3, the method is applied in an LBO scenario and includes the following steps.

At step 301, a first notification message transmitted from a core network is received. The first notification message contains an identifier of a UE to be intercepted.

At step 302, a reattachment instruction is transmitted to the UE to be intercepted based on the identifier of the UE to be intercepted.

At step 303, the UE to be intercepted is attached to the core network upon receiving an attachment message transmitted from the UE to be intercepted, to enable an LI device to intercept traffic data for the UE to be intercepted.

In a feasible solution, the method can include, subsequent to receiving the first notification message transmitted from the core network: associating the UE to be intercepted with a mark. The operation of attaching the UE to be intercepted to the core network upon receiving the attachment message transmitted from the UE to be intercepted can include: determining whether the attachment message is transmitted by the UE to be intercepted based on the mark; and attaching the UE to be intercepted to the core network when the attachment message is transmitted by the UE to be intercepted.

In a feasible solution, the method can include: receiving a second notification message indicating that the core network has set the UE to be intercepted as a non-LBO UE; and transmitting the traffic data for the UE to be intercepted to the core network based on the second notification message.

In particular, the second notification message is received after the received attachment message has been transmitted to the core network and the core network has determined that the UE transmitting the attachment message is the UE to be intercepted and set the UE to be intercepted as a non-LBO UE.

In a feasible solution, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

For further details, reference can be made to the above embodiments and descriptions thereof will be omitted here.

With the present disclosure, upon obtaining an interception command containing an identifier of a UE to be intercepted, it is determined whether the UE to be intercepted is an LBO UE based on the identifier of the UE to be intercepted. When the UE to be intercepted is an LBO UE, a first notification message is transmitted to a base station serving the UE to be intercepted to cause the UE to be intercepted to be reattached. Upon receiving an attachment message associated with the UE to be intercepted as transmitted from the base station, the UE to be intercepted is set as a non-LBO UE to enable an LI device to intercept traffic data for the UE to be intercepted. The present disclosure can provide LI of user data in the LBO scenario by routing data traffic of the UE to be intercepted back to a core network, without modifications to the existing communication structure.

In order to further explain the technical idea of the present disclosure, the solutions according to the present disclosure will be explained below with reference to a specific application scenario. In particular, a UE to be intercepted, 139********, has its traffic subjected to LBO. Here, the UE to be intercepted has an identifier of 139********. The traffic of the UE can be routed back to a core network as follows.

1. Upon receiving an interception command carrying the identifier of the UE to be intercepted, an LI device transmits the identifier of the UE to be intercepted to an HSS, such that the HSS can transmit an MME to which the UE to be intercepted belongs to the LI device based on the identifier.

2. The LI device transmits to the MME to which the UE to be intercepted belongs the interception command carrying the identifier of the UE to be intercepted.

3. The MME determines whether the UE to be intercepted is an LBO UE based on the identifier.

4. If the UE to be intercepted is an LBO UE, the MME associates the UE to be intercepted with a mark and transmits a reattachment notification message carrying the identifier to a base station serving the UE to be intercepted.

5. The base station associates the UE to be intercepted with a mark and transmits the reattachment notification message to the UE to be intercepted.

6. The UE to be intercepted transmits a reattachment message to the base station in response to the notification message.

7. Upon receiving the reattachment message, the base station determines whether the UE transmitting the reattachment message is a UE to be intercepted or not based on the mark.

8. When the UE transmitting the reattachment message is a UE to be intercepted, the reattachment message is transmitted to the MME.

9. The MME determines whether the UE transmitting the reattachment message is a UE to be intercepted or not based on the mark.

10. When the UE transmitting the reattachment message is a UE to be intercepted, the MME sets the UE as a non-LBO UE and transmits a message indicating the setting to the base station serving the UE to be intercepted.

When the above operations have completed, upon receiving traffic data transmitted from the UE to be intercepted, the base station serving the UE to be intercepted does not apply LBO, but instead transmits the traffic to the core network. In this way, the data for the LBO UE can be routed back, such that the core network can acquire all traffic data of the UE to be intercepted. With any existing interception method, LI can be applied to the LBO UE to be intercepted in the core network.

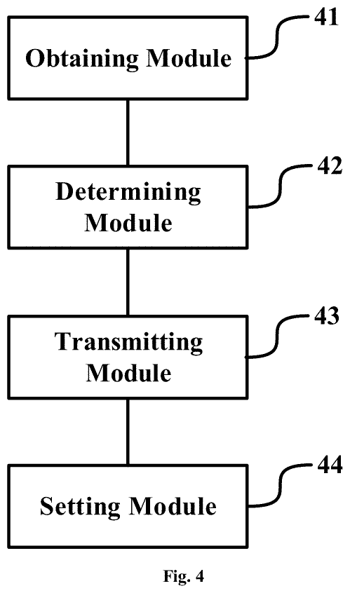

Based on the same concept as the above method, a core network device is provided. As shown in FIG. 4, the core network device includes:

an obtaining module 41 configured to obtain, in a Local Break Out (LBO) scenario, an interception command containing an identifier of a User Equipment (UE) to be intercepted;

a determining module 42 configured to determine whether the UE to be intercepted is an LBO UE based on the identifier of the UE to be intercepted;

a transmitting module 43 configured to transmit, when the UE to be intercepted is an LBO UE, a first notification message to a base station serving the UE to be intercepted to cause the UE to be intercepted to be reattached; and

a setting module 44 configured to set the UE to be intercepted as a non-LBO UE upon receiving an attachment message associated with the UE to be intercepted as transmitted from the base station, to enable a Lawful Interception (LI) device to intercept traffic data for the UE to be intercepted.

In a feasible solution, the core network device can further include: a marking module configured to associate the UE to be intercepted with a mark, after the determining module has determined that the UE to be intercepted is an LBO UE based on the identifier of the UE to be intercepted. The setting module can be configured to: determine whether the attachment message transmitted from the base station is transmitted by the UE to be intercepted based on the mark; and set the UE to be intercepted as a non-LBO UE when the attachment message transmitted from the base station is transmitted by the UE to be intercepted.

In a feasible solution, the transmitting module can be further configured to: transmit to the base station a second notification message carrying an identifier of the UE to be intercepted that has been set as a non-LBO UE to enable the base station to transmit the traffic data for the UE to be intercepted to a core network based on the second notification message.

In a feasible solution, the first notification message can further cause the base station to associate the UE to be intercepted with a mark, such that the base station transmits the attachment message after determining that the UE transmitting the attachment message is the UE to be intercepted based on the mark.

In a feasible solution, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

With the present disclosure, upon obtaining an interception command containing an identifier of a UE to be intercepted, it is determined whether the UE to be intercepted is an LBO UE based on the identifier of the UE to be intercepted. When the UE to be intercepted is an LBO UE, a first notification message is transmitted to a base station serving the UE to be intercepted to cause the UE to be intercepted to be reattached. Upon receiving an attachment message associated with the UE to be intercepted as transmitted from the base station, the UE to be intercepted is set as a non-LBO UE to enable an LI device to intercept traffic data for the UE to be intercepted. The present disclosure can provide LI of user data in the LBO scenario by routing data traffic of the UE to be intercepted back to a core network, without modifications to the existing communication structure.

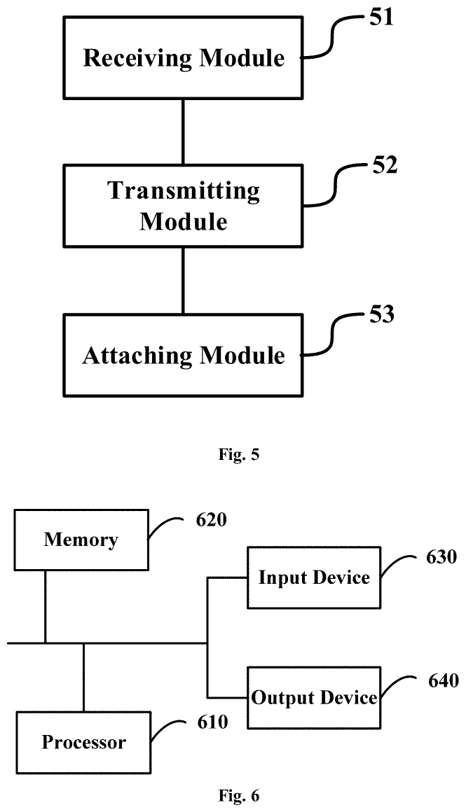

Based on the same concept as the above method, a base station is provided. As shown in FIG. 5, the base station includes:

a receiving module 51 configured to receive, in a Local Break Out (LBO) scenario, a first notification message containing an identifier of a User Equipment (UE) to be intercepted as transmitted from a core network;

a transmitting module 52 configured to transmit to the UE to be intercepted a reattachment instruction based on the identifier of the UE to be intercepted; and

an attaching module 53 configured to attach the UE to be intercepted to the core network upon receiving an attachment message transmitted from the UE to be intercepted, to enable a Lawful Interception (LI) device to intercept traffic data for the UE to be intercepted.

In a feasible solution, the base station can further include: a marking module configured to associate the UE to be intercepted with a mark, after the first notification message transmitted from the core network has been received. The attaching module can be configured to: determine whether the attachment message is transmitted by the UE to be intercepted based on the mark; and attach the UE to be intercepted to the core network when the attachment message is transmitted by the UE to be intercepted.

In a feasible solution, the receiving module can be further configured to receive a second notification message indicating that the core network has set the UE to be intercepted as a non-LBO UE, and the transmitting module can be further configured to transmit the traffic data for the UE to be intercepted to the core network based on the second notification message.

In a feasible solution, the second notification message is received after the received attachment message has been transmitted to the core network and the core network has determined that the UE transmitting the attachment message is the UE to be intercepted and set the UE to be intercepted as a non-LBO UE.

In a feasible solution, the identifier of the UE to be intercepted can include at least one or more of: International Mobile Subscriber Identity (IMSI), International Mobile station Equipment Identity (IMEI), Mobile Subscriber Integrated Services Digital Network Number (MSISDN) or Network Access Identity (NAI).

With the present disclosure, upon obtaining an interception command containing an identifier of a UE to be intercepted, it is determined whether the UE to be intercepted is an LBO UE based on the identifier of the UE to be intercepted. When the UE to be intercepted is an LBO UE, a first notification message is transmitted to a base station serving the UE to be intercepted to cause the UE to be intercepted to be reattached. Upon receiving an attachment message associated with the UE to be intercepted as transmitted from the base station, the UE to be intercepted is set as a non-LBO UE to enable an LI device to intercept traffic data for the UE to be intercepted. The present disclosure can provide LI of user data in the LBO scenario by routing data traffic of the UE to be intercepted back to a core network, without modifications to the existing communication structure.

According to an embodiment, a non-transitory computer readable storage medium is also provided. The non-transitory computer readable storage medium stores computer instructions causing a computer to execute the method according to any of the above method embodiments of the present disclosure.

According to an embodiment, a computer program product is also provided. The computer program product includes a computer program stored on a non-transitory computer readable storage medium. The computer program includes program instructions which, when executed by a computer, cause the computer to execute the method according to any of the above method embodiments of the present disclosure.

FIG. 6 is a schematic diagram showing a hardware structure of an electronic device that performs the interception method according to an embodiment. As shown in FIG. 6, the electronic device includes one or more processors 610 and a memory 620. FIG. 6 illustrates one processor 610 as an example.

The electronic device can further include an input device 630 and an output device 640.

The processor 610, the memory 620, the input device 630 and the output device 640 can be connected via a bus or by other means. FIG. 6 illustrates a bus connection as an example.

As a non-transitory computer readable storage medium, the memory 620 can be configured to store a non-transitory software program, a non-transitory computer executable program and modules, for example, program instructions/modules (for example, the obtaining module 41, determining module 42, transmitting module 43 and setting module 44 as shown in FIG. 4, or the receiving module 51, transmitting module 52 and attaching module 53 as shown in FIG. 5) corresponding to the interception method in the embodiment of the present disclosure. The processor 610 executes various functional applications and data processing of a server through running of the non-transitory software program, instruction and module stored in the memory 620. In this way, the interception method in the above embodiment can be executed.

The memory 620 can include a program memory area and a data memory area. The program memory area can store an operating system and an application program required by at least one function. The data memory area can store data that are created in accordance with application of the core network device and the base station. Moreover, the memory 620 can include a high-speed random access memory, and can further include a non-transitory memory, such as at least one disk memory, a flash memory or other non-transitory solid-state memories. In some embodiments, the memory 620 can include memories which are remotely disposed relative to the processor 610. These remote memories can be connected to the core network device and the base station through networks which include but not limited to Internet, Intranet, local area network, mobile radio communications and a combination thereof.

The input device 630 can receive input digital or character information and generate key signal inputs relevant to user settings and functional control of the core network device and the base station. The output device 640 can include a display device such as a display screen.

The one or more modules are stored in the memory 620. The modules, when executed by one or more processors 60, perform the interception method in any of the above method embodiments.

The above product can execute the method provided by the embodiment of the present disclosure and have corresponding functional modules and beneficial effects for executing the method. For the technical details not described in the present embodiment, reference can be made to the method provided by the embodiment of the present disclosure.

The electronic device provided by the embodiment of the present disclosure can be embodied in various forms, including but not limited to the followings.

(1) Mobile communication equipment: those having the feature of a mobile communication function and the main objective of providing voice and data communication, and including a smart phone (e.g., iPhone), a multimedia mobile phone, a functional mobile phone, a low-end mobile phone, etc.

(2) Ultra-mobile personal computer equipment: those belonging to personal computers, having computing and processing functions, generally having a mobile Internet access feature and including PDAs, MIDs, UMPCs, etc., for example, iPads.

(3) Portable recreation equipment: those being capable of displaying and broadcasting multimedia contents and including audio and video players (e.g., iPods), a hand-held game player, an e-book, intelligent toys and portable vehicle-mounted navigation equipment.

(4) Servers: those providing computing service and including a processor, a hard disk, an internal memory, a system bus, etc., having a similar architecture to a universal computer and placing higher demands on the processing capability, the stability, the reliability, the security, the expandability, the manageability, etc., due to the need for providing high-reliability services.

(5) Other electronic devices with data interaction functions.

The serial numbers of the embodiments of the present disclosure are merely for description, and do not represent the advantages and disadvantages of the embodiments.

In the above-mentioned embodiments of the present disclosure, the descriptions of the embodiments have their respective emphases. For the parts that are not detailed in a certain embodiment, reference can be made to the related descriptions of other embodiments.

It should be understood that in the embodiments provided by the present disclosure, the disclosed technical contents can be achieved by other means. The device embodiments described above are merely schematic. For example, the partitioning of the units can be a logical functional partitioning. There may be other partitioning modes during actual implementation. For example, multiple units or components can be combined or integrated into another system, or some features can be ignored or not executed. In addition, mutual coupling or direct coupling or communication connection that is shown or discussed can be indirect coupling or communication connection through some interfaces, units or modules, and can be in electrical or other forms.

The units described as separate components may or may not be physically separated, and the components for unit display may or may not be physical units, that is, may be located in one place or distributed on a plurality of units. Part or all of the units can be selected according to actual needs to achieve the objective of the solutions of the embodiments.

In addition, all functional units in the embodiments of the present disclosure can be integrated into one processing unit. Or, each unit exists physically independently. Or, two or more units can be integrated into one unit. The above integrated units can be embodied in the form of hardware or a software functional unit.

The integrated units, if embodied in the form of the software functional unit and sold or used as a standalone product, can be stored in a computer readable storage medium. Based on such understanding, the technical solution of the present disclosure in essence, or a part that contributes to the related art, or all or part of the technical solution, can be embodied in the form of a software product. The computer software product is stored in a storage medium and includes a plurality of instructions for a computer device (which can be a personal computer, a server, a network device or the like) to perform all or part of the steps of the method described in the embodiments of the present disclosure. The foregoing storage medium includes: a USB flash disk, a Read-Only Memory (ROM), a Random Access Memory (RAM), a removable hard disk, a magnetic disk, an optical disk, or other various media that can store program codes.

The above description merely describes preferable implementations of the present disclosure, and it should be noted that those skilled in the art can also make various improvements and modifications without departing from the principle of the present disclosure. These improvements and modifications should be considered to be within the scope of protection of the present disclosure.

1. An interception method applied in a Local Break Out (LBO) scenario, comprising:
obtaining an interception command containing an identifier of a User Equipment (UE) to be intercepted;
determining whether the UE to be intercepted is an LBO UE based on the identifier of the UE to be intercepted;
transmitting, when the UE to be intercepted is an LBO UE, a first notification message to a base station serving the UE to be intercepted to cause the UE to be intercepted to be reattached; and
setting the UE to be intercepted as a non-LBO UE upon receiving an attachment message associated with the UE to be intercepted as transmitted from the base station, to enable a Lawful Interception (LI) device to intercept traffic data for the UE to be intercepted.

2. The method of claim 1, further comprising, subsequent to determining that the UE to be intercepted is an LBO UE based on the identifier of the UE to be intercepted:
associating the UE to be intercepted with a mark;
wherein said setting the UE to be intercepted as a non-LBO UE upon receiving the attachment message associated with the UE to be intercepted as transmitted from the base station comprises:
determining whether the attachment message transmitted from the base station is transmitted by the UE to be intercepted based on the mark; and
setting the UE to be intercepted as a non-LBO UE when the attachment message transmitted from the base station is transmitted by the UE to be intercepted.

3. The method of claim 1, further comprising:
transmitting to the base station a second notification message carrying an identifier of the UE to be intercepted that has been set as a non-LBO UE to enable the base station to transmit the traffic data for the UE to be intercepted to a core network based on the second notification message.

4. The method of claim 1, wherein the first notification message further causes the base station to associate the UE to be intercepted with a mark, such that the base station transmits the attachment message after determining that the UE transmitting the attachment message is the UE to be intercepted based on the mark.

5. The method of claim 1, wherein the identifier of the UE to be intercepted comprises at least one or more of: International Mobile Subscriber Identity (IMSI), International Mobile station Equipment Identity (IMEI), Mobile Subscriber Integrated Services Digital Network Number (MSISDN) or Network Access Identity (NAI).

6. A core network device, comprising:
an obtaining module configured to obtain, in a Local Break Out (LBO) scenario, an interception command containing an identifier of a User Equipment (UE) to be intercepted;
a determining module configured to determine whether the UE to be intercepted is an LBO UE based on the identifier of the UE to be intercepted;
a transmitting module configured to transmit, when the UE to be intercepted is an LBO UE, a first notification message to a base station serving the UE to be intercepted to cause the UE to be intercepted to be reattached; and
a setting module configured to set the UE to be intercepted as a non-LBO UE upon receiving an attachment message associated with the UE to be intercepted as transmitted from the base station, to enable a Lawful Interception (LI) device to intercept traffic data for the UE to be intercepted.

7. The core network device of claim 6, further comprising:
a marking module configured to associate the UE to be intercepted with a mark, after the determining module has determined that the UE to be intercepted is an LBO UE based on the identifier of the UE to be intercepted;
wherein the setting module is configured to:
determine whether the attachment message transmitted from the base station is transmitted by the UE to be intercepted based on the mark; and
set the UE to be intercepted as a non-LBO UE when the attachment message transmitted from the base station is transmitted by the UE to be intercepted.

8. The core network device of claim 6, wherein the transmitting module is further configured to:
transmit to the base station a second notification message carrying an identifier of the UE to be intercepted that has been set as a non-LBO UE to enable the base station to transmit the traffic data for the UE to be intercepted to a core network based on the second notification message.

9. The core network device of claim 6, wherein the first notification message further causes the base station to associate the UE to be intercepted with a mark, such that the base station transmits the attachment message after determining that the UE transmitting the attachment message is the UE to be intercepted based on the mark.

10. The core network device of claim 6, wherein the identifier of the UE to be intercepted comprises at least one or more of: International Mobile Subscriber Identity (IMSI), International Mobile station Equipment Identity (IMEI), Mobile Subscriber Integrated Services Digital Network Number (MSISDN) or Network Access Identity (NAI).

11. An interception method applied in a Local Break Out (LBO) scenario, comprising:
receiving a first notification message containing an identifier of a User Equipment (UE) to be intercepted as transmitted from a core network;
transmitting to the UE to be intercepted a reattachment instruction based on the identifier of the UE to be intercepted; and
attaching the UE to be intercepted to the core network upon receiving an attachment message transmitted from the UE to be intercepted, to enable a Lawful Interception (LI) device to intercept traffic data for the UE to be intercepted.

12. The method of claim 11, further comprising, subsequent to receiving the first notification message transmitted from the core network:
associating the UE to be intercepted with a mark,
wherein said attaching the UE to be intercepted to the core network upon receiving the attachment message transmitted from the UE to be intercepted comprises:
determining whether the attachment message is transmitted by the UE to be intercepted based on the mark; and
attaching the UE to be intercepted to the core network when the attachment message is transmitted by the UE to be intercepted.

13. The method of claim 11, further comprising:
receiving a second notification message indicating that the core network has set the UE to be intercepted as a non-LBO UE; and
transmitting the traffic data for the UE to be intercepted to the core network based on the second notification message.

14. The method of claim 11, wherein the identifier of the UE to be intercepted comprises at least one or more of: International Mobile Subscriber Identity (IMSI), International Mobile station Equipment Identity (IMEI), Mobile Subscriber Integrated Services Digital Network Number (MSISDN) or Network Access Identity (NAI).

15. A base station, comprising:
a receiving module configured to receive, in a Local Break Out (LBO) scenario, a first notification message containing an identifier of a User Equipment (UE) to be intercepted as transmitted from a core network;
a transmitting module configured to transmit to the UE to be intercepted a reattachment instruction based on the identifier of the UE to be intercepted; and
an attaching module configured to attach the UE to be intercepted to the core network upon receiving an attachment message transmitted from the UE to be intercepted, to enable a Lawful Interception (LI) device to intercept traffic data for the UE to be intercepted.

16. The base station of claim 15, further comprising:
a marking module configured to associate the UE to be intercepted with a mark, after the first notification message transmitted from the core network has been received,
wherein the attaching module is configured to:
determine whether the attachment message is transmitted by the UE to be intercepted based on the mark; and
attach the UE to be intercepted to the core network when the attachment message is transmitted by the UE to be intercepted.

17. The base station of claim 15, wherein
the receiving module is further configured to receive a second notification message indicating that the core network has set the UE to be intercepted as a non-LBO UE, and
the transmitting module is further configured to transmit the traffic data for the UE to be intercepted to the core network based on the second notification message.

18. The base station of claim 15, wherein the identifier of the UE to be intercepted comprises at least one or more of: International Mobile Subscriber Identity (IMSI), International Mobile station Equipment Identity (IMEI), Mobile Subscriber Integrated Services Digital Network Number (MSISDN) or Network Access Identity (NAI).

19. (canceled)

20. (canceled)

21. (canceled)
